(19) United States
(12) Patent Application Publication
(10) Pub. No.: US 2008/0143825 A1
(43) Pub. Date: Jun. 19, 2008

(54) Portable multimedia device

(76) Inventor: Barry Atkinson, Burbank, CA (US)

Correspondence Address: EDWIN TARVER, 16830 Ventura Blvd., SUITE 360, Encino, CA, 91436, US

(21) Appl. No.: 11/642,467

(22) Filed: Dec. 19, 2006

(51) Int. Cl. H04N 9/47

(52) U.S. Cl. 348/53

(57) ABSTRACT

The present invention is a portable multimedia electronic device, comprising an enclosure housing a processing means, a display means for displaying videos and images, a data storage means, data transfer interfaces, a means for supplying power, control means, and a means for viewing videos and images in 3D from outside the enclosure. The means for viewing videos and images is designed to encompass eyes of a user. The control means are located such that they can be operated by the user while viewing images or videos.

### CROSS-REFERENCE TO RELATED APPLICATION

None

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates in general to portable multimedia electronic devices, and more particularly to a portable multimedia device which facilitates viewing of videos and images in 3D.

Several multimedia devices have been developed in art. U.S. Pub. No. 20060075342 to Penning discloses a portable video accessory apparatus adapted to be mated to a handheld computer, such as a personal digital assistant (PDA). The video accessory apparatus adds a video playback and recording functionality to the PDA. The video accessory device is capable of controlling the playback and recording of small form factor optical (SFFO) discs thereby causing the PDA to act in the capacity of a ‘smart’ display module. A video engine of the video accessory may be realized with a small form factor optical (SFFO) disc drive capable of playing back optical discs on the order of 25 to 50 mm in diameter. The small form factor video engine is of comparable dimensions to the PDA device, allowing the two devices, once mated, to have the look and feel of a single integrated unit.

U.S. Pub. No. 20050207726 to Chen discloses a portable audio video electronic recording, storage and playback device. A user can store their music or movies and view them on the built-in color display or on a television. Video can be recorded and stored from any video source. Digital photographs or video can be captured via a built-in camera. A built-in TV tuner provides viewing and recording of television programming. Music can also be recorded from a stereo or computer and played back anytime and anywhere. The audio can be listened to with headphones, with the built-in speaker, or by connecting the device to a stereo. An image viewer allows digital photos to be stored and viewed on the device. Images can be easily transferred between the device, digital cameras and computers. A hard disc drive and memory card port are provided for storing data. An infrared port provides remote control and wireless connectivity.

U.S. Pat. No. 6,556,197 to Van Hook discloses a low cost high performance three dimensional (3D) graphics system that can model a world in three dimensions and project the model onto a two dimensional viewing plane selected based on a changeable viewpoint. The viewpoint can be changed on an interactive, real time basis by operating user input controls such as game controllers. The system rapidly produces a corresponding changing image on the screen of a color television set. The richly featured high performance low cost system is intended to give consumers the chance to interact in real time right inside magnificent virtual 3D worlds to provide a high degree of image realism, excitement and flexibility. An optimum feature set/architecture provides high quality fast moving 3D images and digital stereo sound for video game play and other graphics applications.

The multimedia device of present invention differs from the above devices in that it supports viewing videos and images in 3D and a structure that enables a user to hold the device like a binocular for viewing videos and images.

### SUMMARY

The present invention is a portable multimedia electronic device for viewing videos and images in 3D. The device comprises an enclosure which houses a processing means, a screen for displaying videos and images, a data storage means, a data transfer interface, a power supply means, and control means for controlling media operations. The enclosure includes a pair of openings equipped with lenses. The screen is viewed from outside the enclosure and the type of the lenses and the screen are selected to facilitate 3D viewing.

The device also comprises a video output slot, built-in speakers, a power indicator, a memory card port, a USB port, a headphone output, a power supply input. The device is self sufficient and does not require the use of computer for its processing.

### BRIEF DESCRIPTION OF THE FIGURES

FIGS. 1 and 2 are perspective views of the portable multimedia electronic device of the present invention.

FIG. 3 is an illustration of an exploded view of the device.

### FIGURES—REFERENCE NUMERALS

10 . . . Portable Multimedia Electronic Device
12 . . . Enclosure
14 . . . Base
16 . . . Top Cover
18 . . . Eye Encompassing Portion
20 . . . TFT Screen
22 . . . Lens
24 . . . Control button
26 . . . Screen Divider
28 . . . Hard Disk
30 . . . Memory Card Slot
32 . . . USB Port
34 . . . Speaker
36 . . . Headphone Input
38 . . . Video i-Pod Slot
40 . . . Power Indicator
42 . . . Rechargeable Battery
44 . . . DC Input Port
46 . . . Power On/Off Switch
48 . . . Divider Top
50 . . . Screw

### DETAILED DESCRIPTION

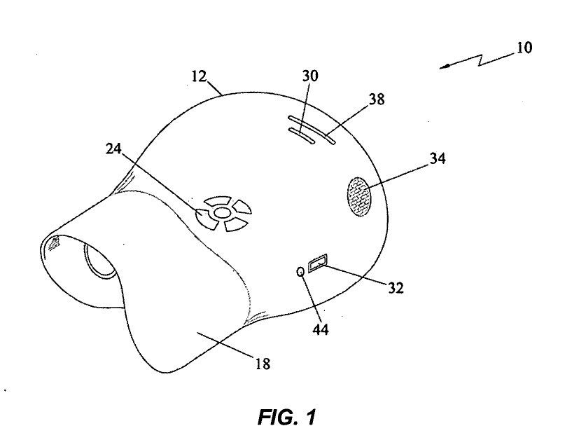

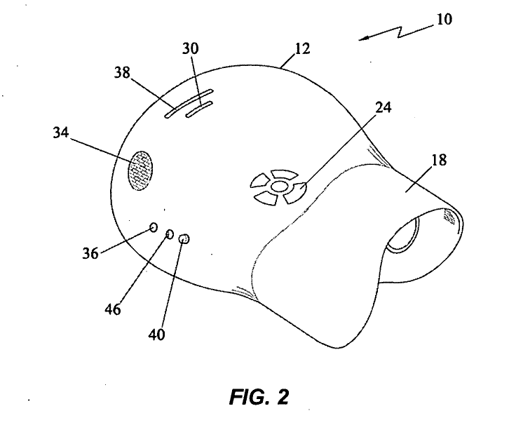

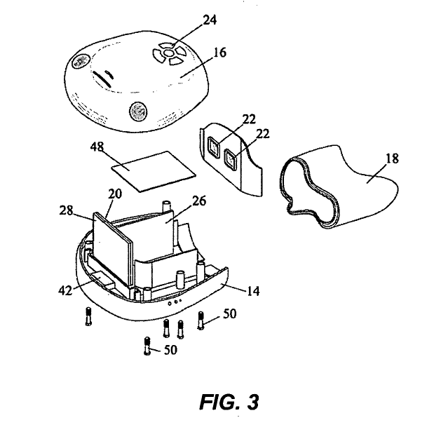

Referring to the drawings, a preferred embodiment of a portable multimedia electronic device is illustrated and indicated as 10 in FIGS. 1 through 3. The device allows viewing of videos and images in 3D.

Referring to FIGS. 1 through 3, the device includes an enclosure 12 having a base 14, a top cover 16 and an eye encompassing portion 18. The enclosure houses a processing means, a TFT (Thin Film Transistor) screen 20, a hard disk 28, a data transfer interface, a power supply and control buttons 24 for controlling various media operations. The device uses a multimedia processor for this operation.

The screen is viewed from outside the enclosure 12, through the eye encompassing portion 18. The eye encompassing portion 18 has two openings equipped with lenses 22. The lenses 22 and the screen 20 together facilitate viewing of videos and images in 3D. The eye encompassing portion 18 is designed to match the contours of the face in order to fully encompass the eyes of a user. The device can therefore be held like a binocular to view videos and images.

The control buttons 26 are located on the top cover 16. These buttons are used to perform multimedia operations such as pause, forward, reverse, play, stop, volume up and volume down. The control buttons 26 can be operated by the user while viewing images or videos.

The multimedia data can be downloaded from any computer or other data sources through data transfer interfaces such as a USB port 32, and SD/MMC slot 30. Additionally, the device can also have a connection means such as a USB port and even an internet network connection port. The power supply comprises a rechargeable lithium battery 42 of DC input. The device also includes speakers 34, a head phone input 36, a DC input port 44, a video output slot 38 for connecting a video i-pod, a power indicator 40 and a power on/off switch 46.

The screen 20 is mounted at one end of the base 14 and the eye encompassing portion 18 is at the opposite end. The hard disk 28 and battery 42 are also mounted on the base. A screen divider 26 extends from the middle of left and right lenses, till the screen. A divider top 48 is placed and the top cover 16 is secured to the base with screws 50.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. § 112, paragraph 6. In particular, the use of “step of” in the claims herein is not intended to invoke the provisions of 35 U.S.C. § 112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A portable multimedia electronic device, comprising:
(a) an enclosure housing:
i) a processing means;
ii) a display means for displaying videos and images;
iii) a data storage means;
iv) a data transfer interface;
v) a means for supplying power; and
vi) control means; and
(b) a means for viewing videos and images in 3D from outside the enclosure.

2. The device of claim 1, further comprising speakers housed in the enclosure.

3. The device of claim 1, wherein the display means comprises a TFT screen.

4. The device of claim 1, wherein the means for viewing videos and images comprises at least one opening equipped with optical elements.

5. The device of claim 4, wherein the optical elements and the display means, in conjunction, facilitate viewing of images or videos in 3D.

6. The device of claim 1, wherein the control means comprises a power on/off switch and a plurality of buttons for controlling media operations.

7. The device of claim 6, wherein the media operations comprise pause, forward, reverse, play, stop, volume up and volume down.

8. The device of claim 1, wherein the means for viewing images and videos comprises a pair of openings, each being equipped with optical elements.

9. The device of claim 8, wherein the optical elements and the display means, in conjunction, facilitate viewing of images or videos in 3D.

10. The device of claim 8, wherein the portion of the housing including the openings is designed to encompass eyes of a user for the device to be held like a binocular in order to view the display means.

11. The device of claim 10, wherein the control means are positioned such that they can be operated by the user while viewing images or videos.

12. The device of claim 1, wherein the means for supplying power comprises a rechargeable battery.

13. The device of claim 1, wherein the means for supplying power comprises a rechargeable lithium battery of DC input.

14. The device of claim 1, wherein the data transfer interface comprises a universal serial bus (USB), USB 2, SD/MMC and internet interface.

15. The device of claim 1 further comprises a DC input, a video output slot, at least one indicator, a memory card port, a USB port, a headphone output, a power supply input.

16. The device of claim 15, wherein the video output slot comprises a video i-Pod slot.

17. The device of claim 15, wherein the at least one indicator comprises a power indicator.

18. The device of claim 1, wherein multimedia support is provided for various file formats comprising AVI, ASF, WMA, MP3, MPEG4, JPEG, BMP and GIF.
